(19) United States
(12) Patent Application Publication
(10) Pub. No.: US 2013/0191200 A1
(43) Pub. Date: Jul. 25, 2013

(54) SECURE MERCHANT INITIATED INTERNET MARKETING WITH CONSUMER PURCHASE VALIDATION SYSTEM

(71) Applicant: Benjamin Wesley Hulet, Washington, UT (US)

(72) Inventor: Benjamin Wesley Hulet, Washington, UT (US)

(21) Appl. No.: 13/674,740

(22) Filed: Nov. 12, 2012

Related U.S. Application Data
(60) Provisional application No. 61/589,814, filed on Jan. 23, 2012.

(51) Int. Cl. G06Q 30/02

(52) U.S. Cl. 705/14.26

(57) ABSTRACT

The present invention provides a means for merchants to advertise and only pay on a per sale basis using a secure method of coupon validation. The system allows merchants to post an advertisement unassisted and/or without a salesperson and it protects consumers from bogus merchants and illegitimate coupons through a secure validation system. The system allows consumers to purchase coupons from a website that were made available by the merchants. The validation system enables the hosting company to allow merchants, not personally known to the hosting company, to post coupons because merchants do not receive the money for services and/or products until the hosting company receives a validation of a coupon and has allowed the consumer a certain time period for satisfaction of the services and/or products purchased with the coupon. The validation system uses unique coupon codes unknown to the merchant until the time of redemption. In the system of the present invention, the merchant does not receive payment until the coupon is redeemed (and an optional time period to file a dissatisfaction has passed). This protects the consumer from fraudulent merchants.

### BACKGROUND OF THE INVENTION

The present invention relates to internet marketing and sales systems and, more particularly, to a secure merchant initiated internet marketing with consumer purchase validation system.

Advertising can be costly, time consuming, difficult, and without measureable results. Also, without a secure means of coupon validation, illegitimate coupons could be sold and used because there is no way to protect consumers from fraudulent merchants or merchants from fraudulent consumers.

In some systems, a merchant may be able to post an advertisement, but would require assistance. This typically would require extra time, labor and money. The advertisement may offer a coupon to a consumer for purchase. In existing systems, a merchant can defraud coupon holders and receive payment even when goods or services are not provided or when the purchaser is dissatisfied with the goods or services.

In other systems, the merchant knows the coupon code and can receive payment for coupons without providing the goods or services covered by the coupon. Also, in still other systems, the merchant receives the payment for the coupon within a few weeks, regardless of whether the coupon is redeemed or not and regardless of whether or not the purchaser is satisfied with the goods or services.

In each of these conventional systems, there is no protection provided to the merchant for fraudulent consumers and there is no protection provided to the consumer for fraudulent merchants.

As can be seen, there is a need for an improved merchant initiated internet marketing system having a consumer purchase validation system.

### BRIEF DESCRIPTION OF THE DRAWINGS

FIGS. 1A through 1E are flow charts describing a system and process according to an exemplary embodiment of the present invention.

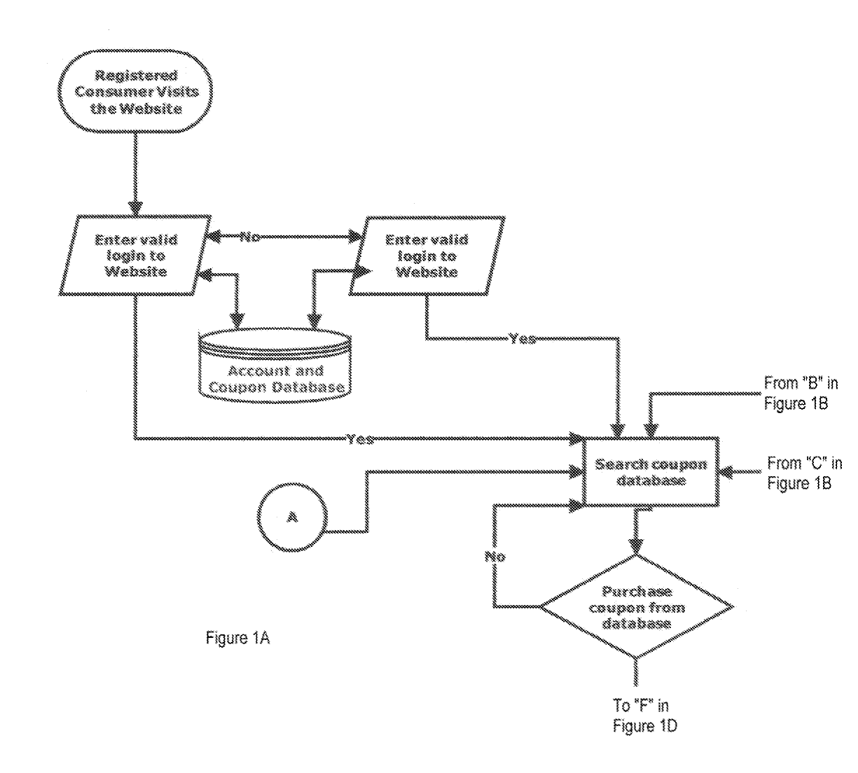

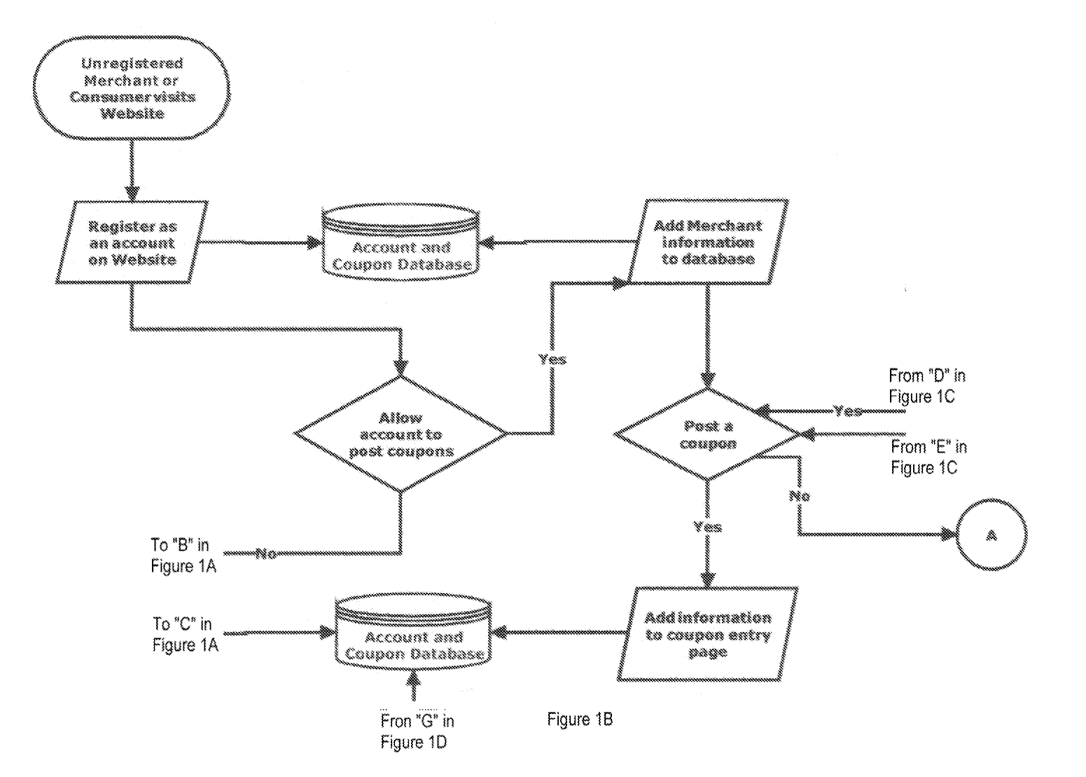

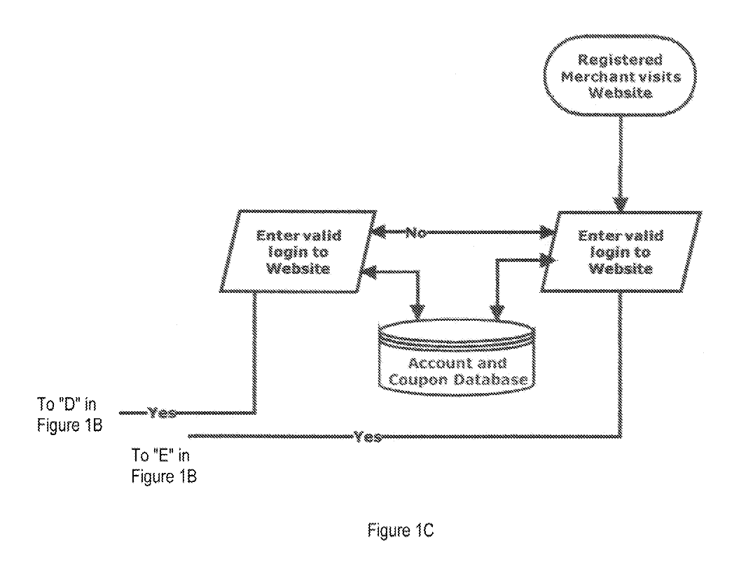

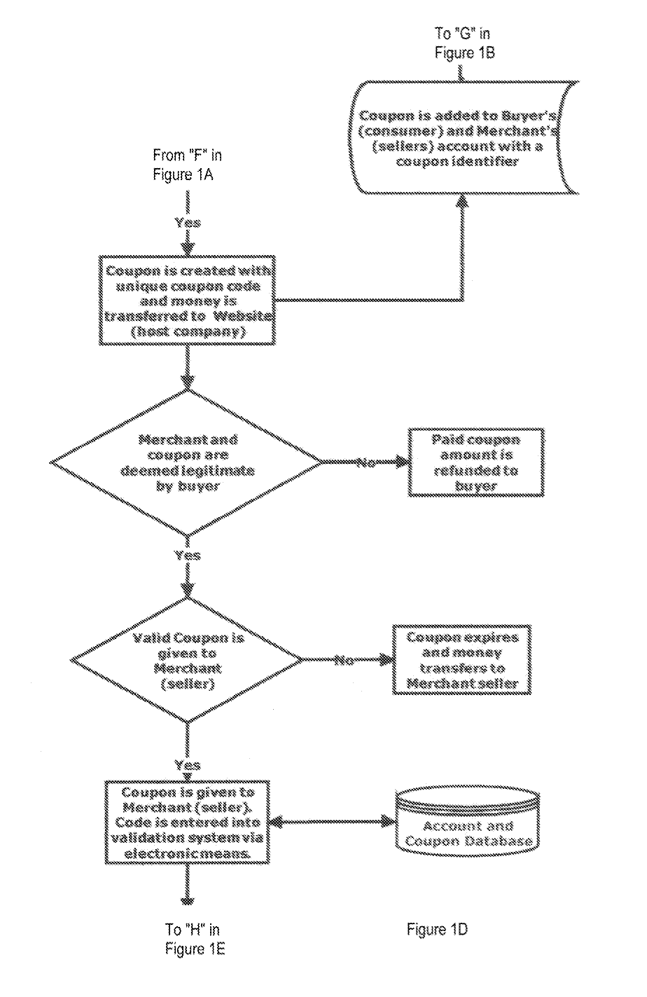

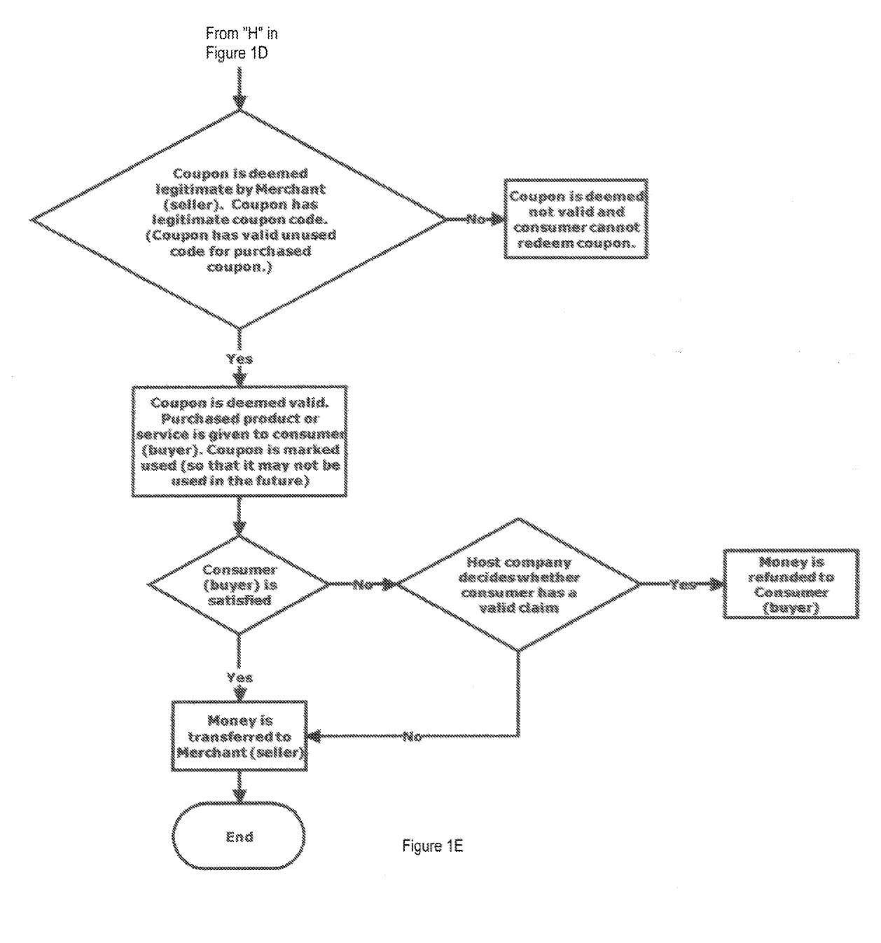

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a means for merchants to advertise and only pay on a per sale basis using a secure method of coupon validation. The system allows merchants to post an advertisement unassisted and/or without a salesperson and it protects consumers from bogus merchants and illegitimate coupons through a secure validation system. The system allows consumers to purchase coupons from a website that were made available by the merchants. The validation system enables the hosting company to allow merchants, not personally known to the hosting company, to post coupons because merchants do not receive the money for services and/or products until the hosting company receives a validation of a coupon and has allowed the consumer a certain time period for satisfaction of the services and/or products purchased with the coupon. The validation system uses unique coupon codes unknown to the merchant until the time of redemption. In the system of the present invention, the merchant does not receive payment until the coupon is redeemed (and an optional time period to file a dissatisfaction has passed). This protects the consumer from fraudulent merchants.

Referring now to the Figures, a unregistered merchant or consumer must first register with the system of the present invention. The system may reside on a computer, such as a server, and a user (merchant or consumer, for example), may access the system running on the computer, via a remote connection, such as via the Internet. In some embodiments, the user may access the system by accessing an internet site. If the user is unregistered, they may register with the system, typically creating an account, including a user identification and a password, for example.

Registered merchants may or may not undergo a verification process. Typically, merchants may register and post coupons to the website without any verification of the hosting company. Registered consumers may sign in and search for coupons for the products or services they seek either. In some embodiments, the search for coupons is done through the use of categories.

If a consumer finds a coupon of interest from a specific merchant, the consumer may purchase the coupon. Once purchased, the coupon is added to the consumer's and merchant's account with a coupon identifier. The consumer may be given a unique coupon code and the money paid for the coupon is transferred to the website (hosting company, or some other holding account, company or the like). The merchant is not made aware of the unique coupon code. The merchant may be provided a notification of the sale of the coupon, however, so that the merchant may be aware of future redemptions.

If either the merchant or consumer are deemed to not be legitimate, the money may be returned to the consumer and the transaction terminated. In some circumstances, the hosting company may keep a portion of the transaction as a transaction fee, for example.

If the merchant and consumer are deemed legitimate, the consumer may, prior to the coupon expiration, redeem the coupon with the merchant. If the coupon expires, in some embodiments, the fees paid for the coupon may be passed to the merchant.

To redeem the coupon, the consumer may provide the unique coupon code to the merchant. The merchant may sign into the website to verify the coupon code. Once verified, the merchant may provide the appropriate goods or services to the merchant. The merchant may then receive payment for the coupon from the hosting company. In some embodiments, the hosting company may retain a service fee from this payment. In other embodiments, the hosting company may charge a fee for a merchant to post a coupon, or may charge a fee upon the sale of a coupon, for example.

In some embodiments of the present invention, before the merchant receives payment for the coupon, a time period may pass, allowing the consumer to file a complaint, or express their dissatisfaction with the merchant. If the consumer's claim of dissatisfaction is valid, then the payment may not be made to the merchant. In some embodiments, before the merchant is paid, the hosting company may require a notice from the consumer that the consumer was satisfied. In other embodiments, a predefined time period, such as 2 days, may be provided to permit the consumer to stop payment to the merchant, pending resolution of the consumer's complaint or dissatisfaction.

Because the money paid for the coupon is not immediately transferred to the merchant, a certain level of protection is provided to the consumer. A consumer may visit the website and purchase a coupon with the knowledge and peace of mind that, if the merchant is not valid or the coupon is not legitimate, their money paid is not lost.

The database, website and validation system, including and not limited to electronic signals via computers, telephones, text messages, and the like, can be made through various processes. These processes may be coded through various computer and internet languages.

The present invention may include a smart phone application or some other resident computer program, for example, a tablet computer program, to provide a user friendly interface for various systems.

Due to the nature of the described process and system, certain processes may be interchanged or shuffled and have the same results. For instance, a consumer may register prior to a given merchant or after the merchant. In some embodiments, a consumer may browse the website (and coupons posted thereupon) as a guest, and may not be required to register. Typically, consumer registration may be required prior to the purchase of a coupon.

It should be understood, of course, that the foregoing relates to exemplary embodiments of the invention and that modifications may be made without departing from the spirit and scope of the invention as set forth in the following claims.

What is claimed is:

1. A method for the sale, validation and redemption of products or services, the method comprising:
permitting a merchant to post a coupon to an online database, the database being searchable with and without the use of categories by a consumer;
collecting funds by a hosting company from the consumer when the consumer purchases the coupon from a website;
providing a unique coupon code to the purchaser which is unknown in part or full to the merchant until redemption;
verifying the coupon code when the consumer provides the coupon code to the merchant for advertised products or services; and
paying the merchant after the consumer redeems the coupon and is satisfied with the merchant's products or services.
